(19) United States
(12) Patent Application Publication
(10) Pub. No.: US 2017/0070705 A1
(43) Pub. Date: Mar. 9, 2017

(54) SYSTEM AND METHOD FOR COLLATING DIGITAL CONTENT FROM A PLURALITY OF DEVICES INTO A SINGLE MEDIA FILE

(71) Applicant: STILLWATER INTERNATIONAL INC., Kent County, DE (US)

(72) Inventors: Oruganti Sandeep KUMAR, Bhilai (IN); Sanjay TATIKONDA, Bangalore (IN); Jagadeesh Reddy PYLA, Vishakhapatnam (IN); Vivek Nurani VISWANATHAN, Bangalore (IN)

(21) Appl. No.: 15/256,461

(22) Filed: Sep. 2, 2016

(30) Foreign Application Priority Data
Sep. 3, 2015 (IN) 1018/CHE/2015

(51) Int. Cl. H04N 7/15; H04N 21/44; H04L 29/06

(52) U.S. Cl. CPC H04N 7/155; H04L 65/403; H04L 65/1069; H04L 65/1073; H04N 21/44016

(57) ABSTRACT

The embodiments herein provides a system and method to simultaneously capture digital content from several geographically separated devices and collate the content automatically into a single media file. The system includes a registration module, a session module, a multimedia capture module, a collating module and a database. The registration module generates a unique identifier. The session module initiates session within a pre-determined time-out period among the participating devices. The multimedia capture module captures the digital contents simultaneously from each participating devices in a session. The collating module is configured to collate the plurality of digital content obtained from the multimedia capture module to generate a single media file in or near real-time. The database stores the captured multimedia from the participating devices and the collated media files.

### CROSS-REFERENCE TO RELATED APPLICATION

The present application claims the priority of the Indian Provisional Patent Application with 1018/CHE/2015 filed on Mar. 3, 2015 with the title, “SYSTEM AND METHOD FOR AUTOMATICALLY AND SIMULTANEOUSLY CAPTURING AND COLLATING DIGITAL CONTENT FROM MULTIPLE DEVICES INTO A SINGLE MEDIA FILE”, and subsequently postdated by 6 months Sep. 3, 2015 and the contents of which is included entirely as reference herein.

### BACKGROUND

Technical Field

The embodiments herein are generally related to a system and method for capturing digital contents from a plurality of devices. The embodiments herein are particularly related to a system and method for capturing simultaneously the digital contents from the plurality of devices that are geographically separated. The embodiments herein are more particularly related to a system and method for collating the simultaneously captured digital content from the plurality of geographically separated devices into a single media file.

Description of the Related Art

Remote access of hardware devices located in geographically different locations is possible through a communication network such as the internet. For a user to access a remotely located multimedia device, the device and the users are connected to the same network, mostly internet. The user is able to access the device without making the geographical separation a limiting factor in using the device. However, there are limitations in the current methods for enabling a device to capture or create a media content, such as image, video or audio, a plurality of objects and people situated across a plurality of mutually different geographic locations and/or time zones.

The currently used methods for remote capturing of the content involves the use of a master device and one or more slave devices located in the same line of vision, dependent on an optical light signal emitted by the master device. The master device drives the entire event of capturing information. When all the users involved are intended to collate the captured information into a single media file, a plurality of media files are created with different timestamps due to lack of precision in synchronization of action between users. In addition to the above, manual collation and synchronization of a plurality of media content are tedious and imprecise.

Hence, there is a need for a system and method to create a session and invite a plurality of users across the mutually different geographical locations and/or time zones to simultaneously create a multimedia content from the plurality of geographically separated devices and automatically collate the content into a single media file. There is also a need for the system to enable all the participating users with same roles and equal privileges.

The above-mentioned shortcomings, disadvantages, and problems are addressed herein, which will be understood by reading and studying the following specification.

### OBJECTS OF THE EMBODIMENTS HEREIN

The primary object of the embodiments herein is to provide a system and method to capture a digital content from a plurality of geographically separated devices and collate the content automatically into a single media file.

Another object of the embodiments herein is to provide a system and method to enable the plurality of users across the geographical locations and/or time zones to simultaneously create a multimedia content from the plurality of geographically separated devices and automatically collate the content into a single media file.

Yet another object of the embodiments herein is to provide a system and method to create a session to invite the plurality of users across the plurality of mutually different geographical locations and/or time zones to simultaneously create a multimedia content from the plurality of geographically separated devices to enable all the participating users with same roles and equal privileges in content creation.

Yet another object of the embodiments herein is to provide a system and method to create a session and invite the plurality of users across the plurality of mutually different geographical locations to simultaneously create multimedia content from the plurality of geographically separated devices, to enable all the participating users to initiate real-time and synchronous capture of multimedia content, by accessing all other participant's devices, apart flora the device at the user's own node.

Yet another objective of the embodiments herein is to provide a system and method to create a session and invite a plurality of users across the geographical locations to simultaneously create multimedia content from a plurality of geographically separated devices and enable all the participating users to initiate real-time and synchronous capture of multimedia content from one or more of the participating users devices.

Yet another object of the embodiments herein is to provide a system and method to create a session to invite the plurality of users across a plurality of mutually different geographical locations to simultaneously capture multimedia content from the a plurality of geographically separated devices to collate all the contents from the plurality of user devices to produce a collated media file and share it with each participating user.

Yet another object of the embodiments herein is to provide a system and method to create a session to invite the plurality of users across the geographical locations to simultaneously capture a multimedia content from the plurality of geographically separated devices and enable a real-time synchronization to collate the content captured from the a plurality of devices.

These and other objects and advantages of the embodiments herein will become readily apparent from the following detailed description taken in conjunction with the accompanying drawings.

### SUMMARY

The various embodiments of the embodiments herein provide a system and method to simultaneously capture a digital multimedia content such as images, video, audio etc. from a plurality of geographically separated devices and collate the content automatically into a single media file.

The system includes a plurality of participating devices, an application server and a database communicably coupled to each other through a communication network. The application server further includes a registration module, a session module, a multimedia capture module, a database module, a collation module, a hardware processor and memory.

The registration module is configured to register a plurality of participating devices. Once the participating devices are registered by creating the login credentials, the registration module is configured to generate a unique identifier for each of the registered participating devices.

The session module is configured to initiate a session within a pre-determined time-out period among a plurality participating devices. The session is initiated when one of the participating devices requests for a session initiation.

The multimedia capture module is configured to capture a plurality as digital content simultaneously from each participating device in a session. The multimedia capture module is configured to capture the digital content from the plurality of participating devices using simul-click technology.

The collating module is configured to collate the plurality of digital contents obtained from the multimedia capture module to generate a single media file. The collating module is configured to collate the plurality of digital contents in real-time/near real time.

The database is configured to store the captured multimedia from the plurality of the participating devices and the plurality of collated media files. The database is configured to store the digital content for a predetermined period. The predetermined period is set by an administrator of the system.

According to an embodiment herein, the session module is configured to initiate the session between a selected number of participating devices by inviting each selected participating device, and wherein the number of participating devices to be joined in a session is selected by a master participating device.

According to an embodiment herein, the collating module is configured to share the collated digital content of the session to each participating device invited in the session.

According to an embodiment herein, the session module is configured to terminate the session after the completion of the time-out period.

According to an embodiment herein, the multimedia capture module is configured to capture the digital content through the camera of the each participating device.

According to an embodiment herein, the multimedia capture module is configured to capture the images from the plurality of the participating devices simultaneously, when the master participating device is configured to initiate the session without an active participation of the other participating devices.

According to an embodiment herein, the plurality of the participating devices is located in a plurality of mutually different geographical locations.

According to an embodiment herein, a method for collating a plurality of digital content from a plurality of participating devices is provided. The method includes the steps of registering a plurality of participating devices. A session is initiated between a selected number of the participating devices. A plurality of digital contents is captured from the plurality of the selected participating devices. The plurality of the captured digital content is collated into a single media file. The plurality of the captured digital contents is collated into a single media file.

According to an embodiment herein, the plurality of the participating devices is registered to the application server with a registration module. Once the participants are registered, a unique identifier is generated and tagged to the user.

According to an embodiment herein, the session is initiated between the selected numbers of the participating devices to transmit a digital content within a pre-determined tune-out period through the session module The session is initiated by the session module, when one of the participating devices requests for a session initiation.

According to an embodiment herein, the captured digital content from the plurality of participating devices and the plurality of collated media files are stored in a database. The digital content and the media file are stored for a pre-determined period specified by authorized personnel.

According to an embodiment herein, the session is initiated between the plurality of the participating devices, when a master participating device is configured to invites the other participating devices.

According to an embodiment herein, the session for transmitting the digital content is terminated after the completion of the time-out period, so that the invited participating devices are restricted from transmitting the digital content for the session after the elapse of time-out period.

According to an embodiment herein, the step of capturing the digital content includes capturing one or more images through the camera of the participating device.

According to an embodiment herein, the step of capturing the digital content from the plurality of the participating devices includes active participation of the master participating device and passive participation of the other participating devices. The active participation includes selecting a capture option from the participating device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG. 1 illustrates a block diagram of a system for simultaneous capture and automatic collation of a digital multimedia content from a plurality of geographically separated devices into a single media file, according to one embodiment herein.

FIG. 2 illustrates a flow chart explaining the method for simultaneous capture and automatic collation of a digital multimedia content from the plurality of geographically separated devices into a single media file, according to one embodiment herein.

FIG. 3 illustrates a process flowchart indicating the process steps involved in the method for simultaneous capture and automatic collation of a digital multimedia content from the plurality of geographically separated devices into a single media file, according to one embodiment herein.

FIG. 4 illustrates a block diagram of a system for collating the digital contents from the plurality of the participating devices, according to an embodiment herein.

FIG. 5 illustrates an implementation of a system for collating the digital contents from the plurality of the participating devices according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the embodiments herein provide a system and method to simultaneously capture a digital multimedia content such as images, video, audio etc. from a plurality of geographically separated devices and collate the content automatically into as single media file.

According to an embodiment herein, the system includes a plurality of participating devices, an application server and a database communicably coupled to each other through a communication network. The application server further includes a registration module, a session module, a multimedia capture module, a database module, a collation module, a hardware processor and memory.

The registration module is configured to register as plurality of participating devices. Once the participating devices are registered by creating the login credentials, the registration module is configured to generate a unique identifier for each of the registered participating devices.

The session module is configured to initiate a session within a pre-determined time-out period among a plurality participating devices. The session is initiated when one of the participating devices requests for a session initiation. The participating device that initiates the session, herein termed the master participating device, then invites all other participating devices to join in the session.

The multimedia capture module is configured to capture a plurality as digital content simultaneously from each participating device in a session. The multimedia capture module is configured to capture the digital content via the cameras of all participating devices, from the plurality of participating devices using simul-click technology.

The collating module is configured to collate the plurality of digital contents obtained from the multimedia capture module to generate a single media file. The collating module is configured to collate the plurality of digital contents in real-time/near real time and then share the collated digital content of the session to each participating device invited in the session.

The database is configured to store the captured multimedia from the plurality of the participating devices and the plurality of collated media files. The database is configured to store the digital content for a predetermined period. The predetermined period is set by an administrator of the system.

According to an embodiment herein, the session module is configured to initiate the session between a selected number of participating devices by inviting each selected participating device, and wherein the number of participating devices to be joined in a session is selected by a master participating device.

According to an embodiment herein, the collating module is configured to share the collated digital content of the session to each participating device invited in the session.

According to an embodiment herein, the session module is configured to terminate the session alter the completion of the time-out period.

According to an embodiment herein, the multimedia capture module is configured to capture the digital content through the camera of the each participating device.

According to an embodiment herein, the multimedia capture module is configured to capture the images from the plurality of the participating devices simultaneously, when the master participating device is configured to initiate the session without an active participation of the other participating devices.

According to an embodiment herein, the plurality of the participating devices is located in a plurality of mutually different geographical locations.

According to an embodiment herein, a method for collating a plurality of digital content from a plurality of participating devices is provided. The method includes the steps of registering a plurality of participating devices. A session is initiated between a selected number of the participating devices. A plurality of digital contents is captured from the plurality of the selected participating devices. The plurality of the captured digital content is collated into a single media tile. The plurality of the captured digital contents is collated into a single media file.

According to an embodiment herein, the plurality of the participating devices is registered to the application server with a registration module. Once the participants are registered, a unique identifier is generated and tagged to the user.

According to an embodiment herein, the session is initiated between the selected numbers of the participating devices to transmit a digital content within a pre-determined time-out period through the session module. The session is initiated by the session module, when one of the participating devices requests for a session initiation.

According to an embodiment herein, the captured digital content from the plurality of participating devices and the plurality of collated media files are stored in a database. The digital content and the media file are stored for a pre-determined period specified by authorized personnel.

According to an embodiment herein, the session is initiated between the plurality of the participating devices, when a master participating device is configured to invite the other participating devices.

According to an embodiment herein, the session for transmitting the digital content is terminated after the completion of the time-out period, so that the invited participating devices are restricted from transmitting the digital content for the session after the elapse of time-out period.

According to an embodiment herein, the step of capturing the digital content includes capturing one or more images through the camera of the participating device(s).

According to an embodiment herein, the step of capturing the digital content from the plurality of the participating devices includes active participation of the master participating device and passive participation of the other participating devices. The active participation includes selecting a capture option from the participating device.

The various embodiments herein provide a system and method to simultaneously capture digital multimedia content such as images, video, audio etc. from a plurality of geographically separated devices and collate the content automatically into a single media file.

According to one embodiment herein, a system and method are provided to enable the plurality of users across the geographical locations and/or time zones to create a multimedia content from the plurality of geographically separated devices and automatically collate the content into a single media file. A session or event is initiated by one of the users by creating a real-time synchronous session that any of the user. All the participating users are enabled to create and invite other users to participate in a session or event. Once all of the intended users have joined the session, any one of the participating users triggers an event to capture content such as an image, video, audio etc. The content is captured from all the participating users' devices at the same time. Once the content capturing process is completed by all the user devices, the system is configured to collate the content from all participants and perform a quality check and processing activities on the collated content. The system then merges all the processed data from the plurality of devices into a single content. The final media file is shared with all of the participants.

According, to one embodiment herein, a system is provided for a simultaneous capture and automatic collation of a digital multimedia content from the plurality of geographically separated devices into a single media file. One of the plurality of users called the initiator initiates the session or event using the device of the initiator. The device of initiator is connected to the internet through the wired or wireless medium. A plurality of participants of the session or event are connected to the session through the internet and through their devices illustrated through the devices of the plurality of participants.

According to one embodiment herein, a method is provided for the simultaneous capture and automatic collation of a digital multimedia content from the plurality of geographically separated devices into a single media file. The method comprises the following steps. One of the users called the initiator creates a session. The initiator invites other users located in a plurality of geographic locations and/or time zones to join the session. The intended users join the session and one of the participating users triggers an event to capture content. The user triggering the event sets the content type to be created, such as image, video, audio etc. All the other participating users honor the content type. Based on the event, a real-time synchronization is performed to create content of specified type. Each event is identified by a unique identification code. All the contents created during a particular session are stamped with the unique event identification code. The system collates all the processed data from the participating user devices to perform a quality check operation and to carry out processing activities on the collated content to create a single collated media file. After the collated single content is created automatically, this single media file is shared with all the participants.

According to one embodiment of the embodiments herein, a method is provided for the synchronized capture of content from a plum lily of geographically separated users and devices are provided The method comprises the following, process steps. A process is initiated. The user creates a session with a timeout period (X) in seconds and invites other users. The user checks whether an invitee accepts the invite to join the session. When the invitee has not accepted the invitation to join the session, the session is terminated for the invitee who has not accepted the request. When the invite is accepted, the user checks whether the invitee has approved the request before the timeout period. When the time taken for approval is greater than the timeout period, the session is terminated for the user. When the time taken for approval is less than the preset timeout period, the user device waits for (X minus the time taken for the user to accept the request) preset seconds before capturing the content. The devices of all users are configured to capture content respectively. The System is configured to wait until the timer is off. Then the system is configured to collate the content from all users and create a single content. The process is terminated.

The system includes a plurality of participating devices, an application server, and a database communicably coupled to each other through a communication network. The application server further includes a registration module, a session module, a multimedia capture module, a database module, and a collation module.

The registration module is configured to register a plurality of participating devices. Once the participating devices are registered by creating login credentials, the registration module is configured to generate a unique identifier for each of the registered participating devices.

The session module is configured to initiate a session within a pre-determined time-out period among a plurality participating devices. The session is initiated when one of the participating devices requests for a session initiation.

The multimedia capture module is configured to capture a plurality of digital content simultaneously from each of the participating devices in a session. The multimedia capture module is configured to capture the digital content from the plurality of participating devices using simul-click technology.

The collating module is configured to collate the plurality of digital content obtained from the multimedia capture module and generating a single media file. The collating module is configured to collate the plurality of digital content in real-time or near real time.

The database is configured to store the captured multimedia from the plurality of the participating devices and the plurality of collated media files. The database stores the digital content for a predetermined period. The predetermined period is set by an administrator of the system.

According to an embodiment herein, the session module is configured to initiate the session between a selected numbers of participating devices by inviting each of the selected participating devices. The number of participating devices to be joined in a session is selected by a master participating device.

According to an embodiment herein, the collating module is configured to share the collated digital content of the session to each of the participating devices invited in the session.

According to an embodiment herein, the session module is configured to terminate the session after the completion of the time-out period.

According to an embodiment herein, the multimedia capture module is configured to capture the digital content through the camera of the each of the participating device.

According to an embodiment herein, the multimedia capture module is configured to capture the images from the plurality of the participating devices simultaneously When the master participating devices are configured to initiate the session without the active participation of the other participating devices.

According to an embodiment herein, the plurality of the participating devices are located in different geographies.

A method is provided for collating a plurality of digital content from a plurality of participating devices. The method includes the steps of registering a plurality of participating devices., initiating a session between a selected number of the participating devices, capturing a plurality of digital content from the plurality of the selected participating devices, collating the plurality of the captured digital content into a single media file, and collating the plurality of the captured digital content into a single media file.

According to an embodiment herein, a registration module is configured to register the plurality of the participating devices to the application server. Once the participants are registered, a unique identifier is generated and tagged to the user.

According to an embodiment herein, the session is initiated between a selected numbers of the participating devices to transmit a digital content within a pre-determined tune-out period through the session module. The session is initiated by the session module, when one of the participating device is configured to send a request for a session initiation.

According to an embodiment herein, the method further includes storing the captured digital content from the plurality of participating devices and the plurality of collated media files in a database. The digital content and the media file are stored for a pre-determined period specified by authorized personnel.

According to an embodiment herein, the session is initiated between the plurality of the participating devices, when a master participating device is configured to invite the other participating devices.

According to an embodiment herein, the session for transmitting the digital content is terminated after the completion of the time-out period so that the invited participating devices are restricted from transmitting the digital content for the session.

According to an embodiment herein, the step of capturing the digital content includes capturing one or more images through the camera of the participating device.

According to an embodiment herein, the step of capturing the digital content from the plurality of the participating devices includes active participation of the master participating device and passive participation of the other participating devices. The active participation includes selecting a capture option from the participating device.

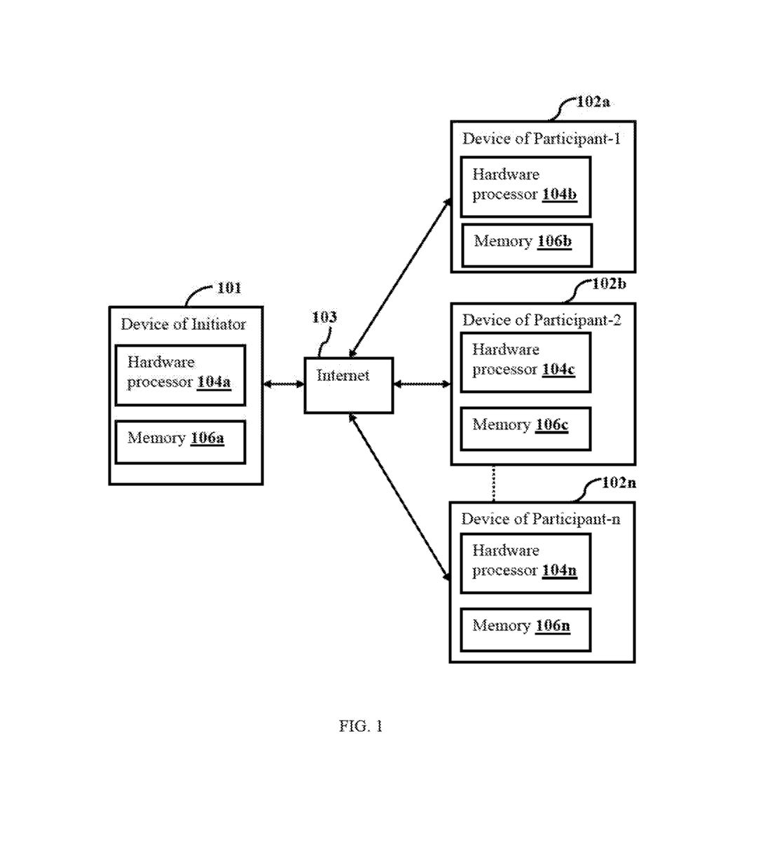

FIG. 1 illustrates a block diagram of a system for simultaneous capture and automatic collation of a digital multimedia content from the plurality of geographically separated devices into a single media file, according to one embodiment herein.

With respect to FIG. 1, one of the plurality of users, called an initiator, initiates the session or event using the device of initiator 101. The device of the initiator 101 is connected to the interact 103 through the wired or wireless medium. A plurality of participants of the session or event connect to the secs through the internet and through their devices illustrated through the device of participant-1, device of participant-2 . . . the device of participant-n.

Further, each participant device 102a, 102b . . . 102n, and the initiator device 101 also includes a hardware processor 104 and a memory module 106. The hardware processor 104 is an electronic circuit that performs a plurality of operations on an external source such as the memory module 106. The hardware processor 104 carries out the instructions by performing operations such as arithmetic, logical, control, input-output, and the like.

The memory module 106 refers to a hardware module that stores information for immediate use of the participating devices. According to an embodiment herein, the memory is synonymous with the term primary storage. The memory module 106 operates as both a primary memory and a secondary memory. Further, the memory module includes both primary memory and secondary memory.

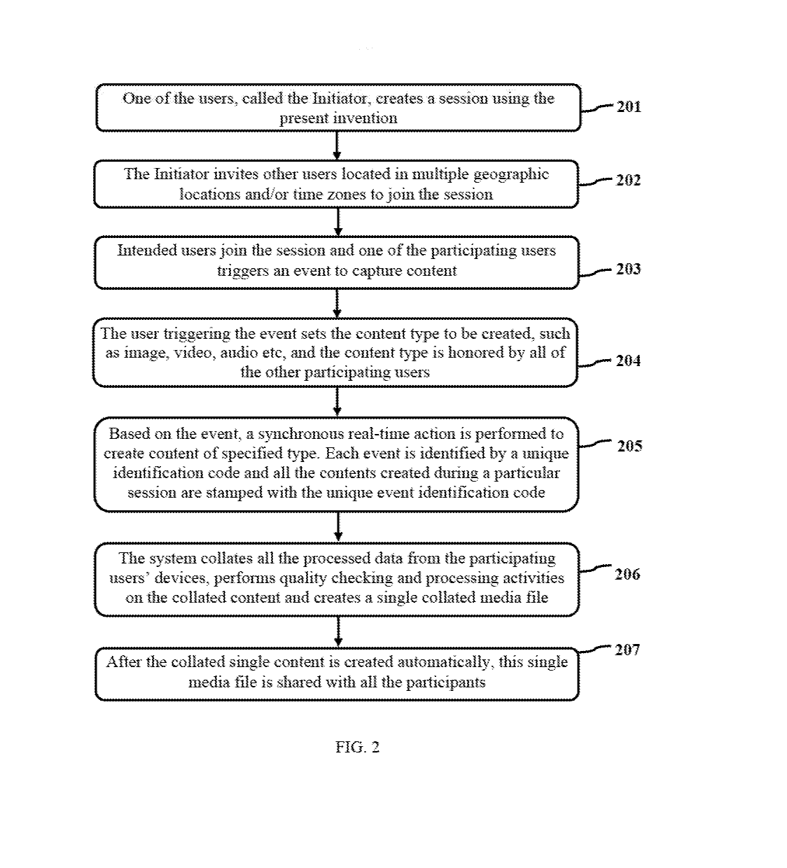

FIG. 2 illustrates a flow chart explaining the method for simultaneous capture and automatic collation of a digital multimedia content from the plurality of geographically separated devices into a single media file, according to one embodiment herein.

With respect to FIG. 2, the method comprises following steps. One of the users called the initiator creates a session (201). The initiator invites other users located in a plurality of geographic locations and/or time zones to join the session (202). The intended users join the session and one of the participating users triggers an event to capture content (203). The user triggering the event sets the content type to be created, such as image, video, audio etc., and the content type is honored by all the other participating users (204). Based on the event, a synchronous real-time action is performed to create content of specified type. Each event is identified by a unique identification code and all the contents created during a particular session are stamped with the unique event identification code (205). The system collates all the processed data from the participating user devices, performs quality checking and processing activities on the collated content and creates a single collated media file (206). After the collated single content is created automatically, this single media file is shared with all the participants (207).

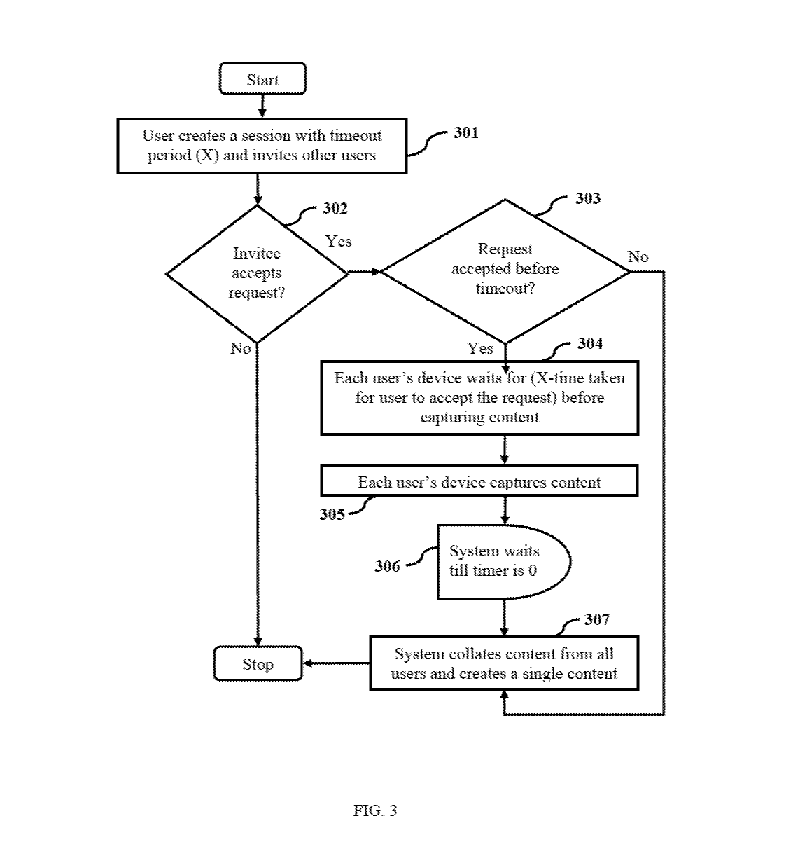

FIG. 3 illustrates a process flowchart indicating the process steps involved in the method for simultaneous capture and automatic collation of a digital multimedia content from the a plurality of geographically separated devices into a single media file, according to one embodiment herein.

With respect to FIG. 3, the process comprises following steps: the process is initiated. The user creates a session with timeout period (X) seconds and invites other users (301). A process is performed to check if an invitee accepts the invite to join the session (302). If the invite is not accepted, the process terminates for the invitee who has not accepted the request. If the invite is accepted, the process is performed to check if the invitee approved the request before the preset timeout period (303). If the time for approval is greater than preset timeout period, the process is terminated for the user. If the time of approval is less than the preset timeout period, the user's device waits for (X minus the time is taken for the user to accept the request) preset seconds before capturing content (304). The devices of all users capture content (305). The system waits until the timer is off (306). The system collates the content from all users and creates a single content (307). The process is terminated.

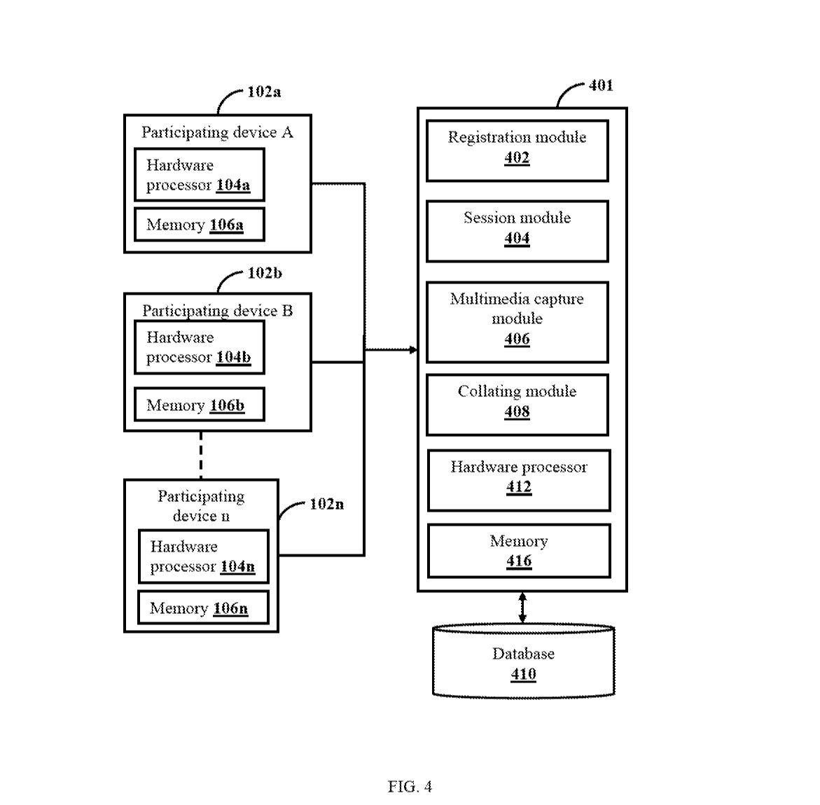

FIG. 4 illustrates a block diagram explaining the process of collating the digital content from the plurality of the participating devices, according to an embodiment herein. The block diagram includes a plurality of participating devices 102a, 102b, 102c . . . 102n, an application server 401, and a database 410. The components mentioned above interact using a communication network such the internet, an intranet, a local area network (LAN), a wide area network (WAN), a telecommunication network, and other forms of wired and wireless networks.

The participating devices 102a, 102b . . . 102n are computing devices capable of transmitting digital content to the application server 401 through the communication network. According to an embodiment herein, the participating devices 102a, 102b . . . 102n has a pre-installed camera that captures images of the user of the participating devices. The examples of the participating devices 102a, 102b . . . 102n includes but are not limited to a smartphone, laptop, a wearable device, a palmtop, a virtual reality device, a smart television, and the like.

The application server 401 includes a plurality of components including but not limited to a registration module 402, a session module 404, a multimedia capture module 406, and a collating module 408.

The registration module 402 registers the user to an application that allows the users to collate digital content from a plurality of the participating. devices. The registration module 402 receives the details such as user name, user address, permissions to access information about the user, geographic location, and the like. Once the user provides the required credentials, the registration module 402 generates a unique identifier for referencing the user for the further processes.

The session module 404 is communicably coupled to the registration module 402 and allows the registered users to initiate a session. For example, when one of the participating devices initiates a session, a request is raised for the session module 404. The session module 404 allows the initiator participating device to invite other participating devices to join the session. According to an embodiment herein, the invite is sent as a notification to the user. The examples of the notification include, but are not limited to text, audio message, video message, push notification, and the like. The invite for the plurality of the participating devices is selected from the contact list of the initiator participating device.

Further, the initiator participating device has the ability to set a time-window in which the other participating devices has to join the session. The other participating devices should accept the invite to join the session by selecting a join option provided on the user interface of the participating devices. According to an embodiment herein, the session module 404 restricts the other participating devices from joining the session when the join option is not selected within the specified time-window.

The multimedia capture module 406 captures the digital content from the plurality of participating devices that has joined the session simultaneously. According to an embodiment herein, oily the initiator of the session initiates the capturing of the digital content, and the other participating devices transmit the digital content passively. For example, when a group of participating devices along with an initiator device is having a session, only the initiator device selects the capture option, and the digital content from all the other participating devices is captured automatically on the countdown of a Timer. In another example, when a group of four people wants to capture a moment (such as selfie) together when they are located in different geographies, one of them initiates a session and sets a countdown timer. The initiator is called the master device and the others pose for the photo. According to an embodiment herein, when the initiator initiates the session, the countdown is shown on all the participating devices.

The application server 401 includes a collating module 408. The collating module collates all the digital content received from the plurality of the participating devices at that session to generate a single media tile. The collating module 408 uses a plurality of image processing techniques for collating the plurality of the digital content into a single media file. The image processing techniques include but are not limited to interpolation, resizing, face detection, resolution calculation, edge detection, border imprinting, concatenation, and the like.

Further, the collating module $08 collates the plurality of digital content in one or more ways For example, the digital content is collated using a spiral Fibonacci series type collation, where the digital content is merged incrementally based on the uploaded time. In this method, the largest digital content of the completed collation appears in half of the entire collation, the second largest appears to in the half of the half of the remaining collection, and so on.

In another method of collating, a proportionate ladder like collation where the image looks proportionate to each other in the final collation is used. The individual images in the collation may not be of exact same size due to the variations in the resolution; however, the collating module 408 maintains the same aspect ratio.

The collation module 408 then completes the collation and shares the generated single media file to the plurality of participating devices of that session. According to an embodiment herein, the generated single media file is shared only with the participating devices participated in the session. According to an embodiment herein, the generated single media file is shared also with the participants who has missed the session due to one or more reasons. Once the collation module 408 completes the collation and sharing of the digital content, the session module 404 terminates the session.

Further, each of the participant device 102a, 102b . . . 102n, also includes a hardware processor 104 and a memory module 106. The hardware processor 104 is an electronic circuit that performs a plurality of operations on an external source such as the memory module 106. The hardware processor 104 carries out the instructions by performing operations suet as arithmetic, logical control, input-output, and the like.

The memory module 106 refers to a hardware module that stores information for immediate use of the participating devices. According to an embodiment herein, the memory is synonymous with the term primary storage. The memory module 106 operates as both a primary memory and a secondary memory. Further, the memory module includes both primary memory and secondary memory.

In the similar lines, the plurality of the components of the application server includes a hardware processor 412 and a memory module 416. The hardware processor 412 is an electronic circuit that performs a plurality of operations on an external source such as the memory module 416. The hardware processor 412 carries out the instructions by performing operations such as arithmetic, logical, control,input-output, and the like.

The memory module 416 refers to a hardware module that stores information for immediate use of the participating devices. According to an embodiment herein, the memory is synonymous with the term primary storage. The memory module 416 operates as both a primary memory and a secondary memory. Further, the memory module includes both primary memory and secondary memo

The database 410 is communicably coupled to the application server 401. The application server 410 stores a plurality of data related to the plurality of participating devices, the application server 410. The data stored in the database 410 include, but are not limited to user credentials, type of the device of the participating device, application server 401 related data, metadata and the like. According to an embodiment herein, the database 410 stores the data for a pre-determined period temporarily. According to an embodiment herein, the database 410 stores the data related to the application server 401 a id the plurality of data permanently.

According to an embodiment herein, the multimedia capture module 406 synchronizes the digital content from the plurality of the devices using, simul-click via a lightweight web socket connection. According to an embodiment herein, the simul-click is lightweight and circulates only for the digital content (collage) generation. This helps in achieving the real-time experience with multi-way acknowledgments for the participating devices.

According to an embodiment herein, the e simul-click refers to a technological implementation where the initiator clicks the photo of geographically separated participants without any explicit physical action by the participants of their devices. It is analogous to one person in a group taking a selfie of the entire group and other participants posing. The simul-click emulates the same concept where the initiator (the person who clicks selfie) captures the image and all the participants, though geographically separated poses as though as they are at same location. The powerful bi-directional communication channel orchestrated by the application server 401 makes sure the communication between the groups is real-time giving a high quality user experience.

According to an embodiment herein, the actual digital content is transferred asynchronously to the server on the trigger of the simul-click. Therefore, the heavy digital content transfer does not hinder the real-time synchronization by multi-way acknowledgments of all the participating devices.

According to an embodiment herein, the collating module 408 resizes, interpolates, and transforms the digital content in a manner that is efficiently viewable. Further, the collation module 408 provides cross-platform and cross operating system support.

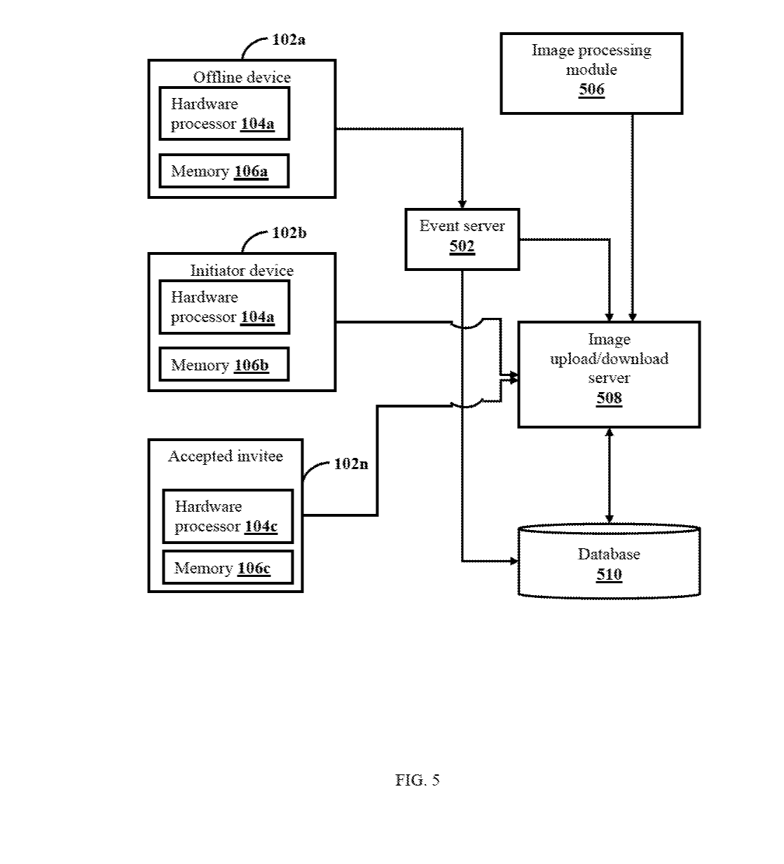

FIG. 5 illustrates an implementation of a system for collating the digital contents from the plurality of the participating devices according to an embodiment herein. The implementation system includes a plurality of components including a plurality of participating device, but not limited to an offline device 102a, an initiator device 102b, an accepted invitee 102c, an event server 502, an image processing module 502, image upload/download server 508, and a database 510.

The initiator device 102b invites one or more devices to participate in the session to transmit digital content. The initiator device 102b invites the other users who are in the contact list of the user device. The offline device 102a is a device that is offline and/or the device that has not responded to the invite sent by the initiator device 102b. The accepted invitee 102c is a participating device that has accepted the invite shared b the initiator device 102b.

The event server 502 is an application server that handles a plurality of events such as initiating a session pushing notifications to plurality of the participating devices, allowing the participating devices to register to the system. Further, the event server 502 initiates the capture of the digital content from the plurality of the participating devices using simul-click technology. The event server is communicably coupled to the participating devices that have accepted the invite and the initiator of the device.

The image processing module 506 processes the images captured from the plurality of the participating devices. The processing of the images include, but are not limited to resizing, resolution checks, face detection, border imprint, and the like. Further, the image-processing module 506 collates the digital content from the plurality of the participating devices using Fibonacci spiral or proportionate mode. Furthermore, the image processing module 506 uses a watermark imprint and further streams the collated content to the storage device. According to an embodiment herein, the image-processing module 506 also triggers an event to the event server 502.

The system includes an image upload/download server 508 that stores the images uploaded and subsequently the image to be downloaded by the participating devices after the collation. According to an embodiment herein, the image upload/download server 508 stores the images temporarily and erases the same after a pre-determined period. According to an embodiment herein, the image upload/download server 508 stores the image until a system administrator deletes the images. The image upload/download server 508 is communicably coupled with the active participating devices to receive the digital content, and also to the database 510 for transmitting the collated digital content and the metadata of the collated digital content.

Further, each participant device 102a, 102b . . . 102n, includes a hardware processor 104a, 104b . . . 104n and a memory module 106a, 106b . . . 106n respectively. The hardware processor 104a, 104b . . . 104n is an electronic circuit that performs a plurality of operations on an external source such as the memory module 106. The hardware processor 104a, 104b . . . 104n carries out the instructions by performing operations such as arithmetic, logical, control, input-output, and the like.

The memory module 106a, 106b . . . 106n refers to a hardware module that stores information for immediate use of the participating devices. According to an embodiment herein, the memory is synonymous with the term primary storage. The memory module 106a, 106b . . . 106n operates as both a primary memory and a secondary memory. Further, the memory module includes both primary memory and secondary memory.

According to an embodiment herein, the system for collating the digital content to a single media file also includes the merging of background with a background file obtained from the session initiator. Further, the image-processing module allows the participants to select a specific background with a plurality of pre-determined media files. According, to an embodiment herein, the image-processing module may also provide filters, text additions, and overlay texts on the preview screen or the collated media. Further, features such as face-mash and chat facility is also provided to enable efficient communication and content sharing between the plurality of the participating devices.

The embodiments herein provides a system and method to simultaneously capture digital content from a plurality of geographically separated devices and collate the content automatically into a single media tile. The currently used methods for remote capturing of content involves the use of a master device and one or more slave devices located in, the same line of vision, dependent on an optical light signal emitted by the master device. In addition, there is a lack of precision in synchronization of action between users and manual collation and synchronization of a plurality of media content are tedious and imprecise. The embodiments herein provides a system and method to create a session and invites a plurality of users across geographical locations and/or time zones to simultaneously create multimedia content from a plurality of geographically separated devices and automatically collate the content into a single media file. The embodiments herein enables a real-time synchronization to collate content captured from the plurality of devices into single media content.

The foregoing description of the specific embodiments will so fully reveal the general nature of the embodiments herein that others can, by applying current knowledge, readily modify and/or adapt for various applications such as specific embodiments without departing from the generic concept., and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

Although the embodiments herein are described with various specific embodiments, it will be obvious for a person skilled in the art to practice the embodiments herein with modifications.

What is claimed is:

1. A system for collating a plurality of digital content from a plurality of participating devices comprising a hardware processor and a memory, the system comprises:
a registration module run on a hardware processor and is configured to register a plurality of participating devices, and wherein the registration module is configured to generate a unique identifier for each of the registered participating devices;
a session module run on a hardware processor and is configured to initiate a session within a pre-determined time-out period among a plurality participating devices, wherein the session is initiated when one of the participating device is configured to send a request for a session initiation;
a multimedia capture module run on a hardware processor and is configured to capture a plurality of digital content simultaneously from each of the participating devices in a session;
a collating module rim on a hardware processor and is configured to collate the plurality of digital content obtained from the multimedia capture module and generating a single media file, and wherein the collating module is configured to collate the plurality of digital contents in real-time or near real time;
a database configured to store the captured multimedia from the plurality of the participating devices and the plurality of collated media files, and wherein the database is configured to store the digital content for a predetermined period, and wherein the predetermined period is set by an administrator of the system.

2. The system according to claim 1, wherein session module is configured to initiate the session between a selected number of participating devices by inviting each of the selected participating devices, and wherein the number of participating devices to be joined in a session is selected by a master participating device.

3. The system according to claim 1, wherein the collating module is configured to share the collated digital content of the session to each of the participating devices invited in the session.

4. The system according to claim 1, wherein the session module is configured to terminate the session after the completion of the time period.

5. The system according to claim 1, wherein the multimedia capture module is configured to capture the digital content through the camera of the each participating device.

6. The system according to claim 1, wherein the multimedia capture module is configured to capture the images from the plurality of the participating devices simultaneously when the master participating device is configured to initiate the session without the active participation of the other participating devices.

7. The system according to claim 1, wherein the plurality of participating devices are located in a plurality of mutually different geographies

8. A computer implemented method comprising instructions stored on a non-transitory computer-readable storage medium and executed on computing device provided with a hardware processor and a memory for collating a plurality of digital contents from a plurality of participating devices, the method comprising the steps of:
registering a plurality of participating devices through a registration module, and wherein each registered participating device is provided with a unique identification number;
initiating a session between a selected number of the participating devices to transmit a digital content within a pre-determined time-out period through the session module, and wherein the session is initiated by the session module when one of the participating device requests for a session initiation;
capturing a plurality of digital content from the plurality of the selected participating devices simultaneously in a session with the multimedia capture module;
collating the plurality of the captured digital content into a single media file, and wherein the single media file is generated in real-time or near real time and
sharing the collated single media file with the plurality of the participating devices participated in the session.

9. The method according to claim 8, wherein the method farther comprises storing the captured digital content from the plurality of participating devices and the plurality of collated media files in a database, wherein the digital content and the media file are stored for a pre-determined period specified by an authorized personnel.

10. The method according to claim 8, wherein the session is initiated between the plurality of the participating devices when a master participating device is configured to invite the other participating devices.

11. The method according to claim 8, wherein the session for transmitting the digital content is terminated after the completion of the time-out period, wherein the invited participating devices are restricted from transmitting the digital content for the session after the elapse or expiry of the time-out period.

12. The method according to claim 8, wherein capturing the digital content includes capturing one or more images through the camera of the participating device.

13. The method according to claim 8, wherein the capturing the digital content from the plurality of the participating devices includes active participation of the master participating device and passive participation of the other participating devices, and wherein the active participation includes selecting a capture option from the participating device.
